(19) United States
(12) Patent Application Publication
(10) Pub. No.: US 2022/0285698 A1
(43) Pub. Date: Sep. 8, 2022

(54) OPTIMIZED ELECTROCHEMICAL REACTOR COLLECTOR

(71) Applicant: ALSTOM Hydrogène SAS, AIX EN PROVENCE CEDEX 4 (FR)

(72) Inventors: Benoit GUENOT, AIX EN PROVENCE (FR); André RAKOTONDRAINIBE, AIX EN PROVENCE (FR); Bruno GENTILS, TOURVES (FR)

(21) Appl. No.: 17/685,154

(22) Filed: Mar. 2, 2022

(30) Foreign Application Priority Data
Mar. 5, 2021 (FR) 21 02163

(51) Int. Cl. H01M 8/0245; H01M 8/0258; H01M 8/1004

(52) U.S. Cl. CPC H01M 8/0245; H01M 8/0258; H01M 8/1004

(57) ABSTRACT

A collector insert is configured to be inserted into a collector of an electrochemical reactor by defining a main conduit therein, which has a cross-sectional area that decreases from a first end to a second end of the main conduit, the collector insert including a connecting wall including a first face adapted to delimit the main conduit and a second face and a plurality of channels, each extending between a first opening located on the first face and a second opening located on the second face, the first openings being distributed along the main conduit and each second opening facing a connection port of the fluid chamber of a respective electrochemical cell when the collector insert is inserted in the collector.

### BACKGROUND OF THE INVENTION

### Field of the Invention

The present invention relates to the field of electrochemical reactors, such as fuel cells or electrolyzers, and in particular to fluid circulation management in such electrochemical reactors.

### Description of the Related Art

It is possible to make an electrochemical reactor such as a fuel cell or an electrolyzer comprising several superimposed electrochemical cells formed using a stack of separator plates and membrane-electrode assemblies (or MEA), with each electrochemical cell formed of a membrane-electrode assembly interposed between two separator plates.

Each membrane-electrode assembly is a laminate of an ion exchange membrane, such as a proton exchange plate, sandwiched between two electrodes.

One function of each separator plate in each electrochemical cell is to channel a fluid for circulation along a face of the membrane-electrode assembly of the electrochemical cell opposite which the separator plate in question is located.

To this end, the separator plate defines along with said face of the membrane-electrode assembly a fluid chamber for circulation of the fluid. The separator plate comprises for example a plurality of grooves delimiting the fluid chamber.

The separator plates are provided with openings, aligned when the separator plates are stacked, to define collectors, each collector being in fluid communication with a fluid chamber of each of the electrochemical cells via a connection port.

Each collector is an inlet collector for supplying fluid to the fluid chambers connected to that collector, or an outlet collector for recovering fluid from the fluid chambers connected to that collector.

For proper operation of an electrochemical reactor comprising a plurality of electrochemical cells, it is desirable to provide uniform fluid flow between the individual electrochemical cells.

A collector, formed through openings in separator plates of a stack of separator plates and membrane-electrode assemblies, extends through the stack, with connection ports connecting fluid chambers of electrochemical cells to this collector distributed along the collector, between an upstream end and a downstream end of the collector.

If the collector is an inlet collector, the amount of fluid in the collector decreases from its upstream end to its downstream end.

This can decrease the flow velocity of the fluid feeding the fluid chambers of the electrochemical cells whose connection ports are located furthest downstream of the collector, and adversely affect the uniformity of the fluid distribution in the electrochemical cells.

To alleviate this problem, it is possible to insert an insert in the collector, the insert being configured to define a conduit inside the collector, the conduit having a cross-sectional area decreasing from the upstream end of the collector to the downstream end of the collector, so as to maintain a substantially constant fluid flow velocity along the conduit.

### SUMMARY OF THE INVENTION

One object of the invention is to provide a collector insert for improving the fluid flow through the various electrochemical cells of an electrochemical reactor.

To this end, the invention provides a collector insert configured to be inserted into a collector of an electrochemical reactor comprising a stack of separator plates and membrane-electrode assemblies that define electrochemical cells, the collector being formed by aligned openings of the separator plates and each of the electrochemical cells comprising a fluid chamber fluidly connected to the collector by a connection port, the collector insert extending along an extension axis and configured to be inserted into the collector with defining a main conduit within the collector, the main conduit having a cross-sectional area that decreases from a first end to a second end of the main conduit, the collector insert comprising a connecting wall comprising a first face adapted to define the main conduit and a second face, and a plurality of channels each extending between a first port located on the first face and a second port located on the second face, the first ports being distributed on the first face so as to be distributed along the main conduit, and the second ports being distributed on the second face such that each second port faces the fluid chamber connection port of a respective electrochemical cell when the collector insert is inserted into the collector.

The provision of a respective channel associated with the connection port of each fluid chamber connected to the collector, which extends between the main conduit and the connection port of that fluid chamber, allows the cross-sectional area, length and/or shape of the channel to be adapted for proper fluid flow between the channel and the connection port of the fluid chamber. In this way, a satisfactory fluid flow between the collector and the fluid chamber connection ports of the electrochemical cells can be achieved, in particular for a uniform fluid flow in the fluid chambers of the electrochemical cells connected to the collector provided with the collector insert.

According to particular embodiments, the collector insert comprises one or more of the following optional features, taken individually or in any technically possible combination:
the collector insert is hollow, the main conduit being delimited within the collector insert;
the collector insert has a channeling wall, the main conduit being defined between an inner face of the channeling wall and the first face of the connecting wall, which face each other;
the inner face of the channeling wall and the first face of the connecting wall are substantially flat and inclined in relation to each other, such that the cross-sectional area of the main conduit decreases from the first end to the second end;
the second face of the connecting wall is substantially flat.
the first ports are elongated and parallel to each other and/or the second ports are elongated and parallel to each other;
the connecting wall has a thickness, taken between the first face and the second face, that is substantially constant from the first end of the main conduit to the second end of the main conduit;
each channel has a length, taken along the channel between its first port and its second port, the channels having substantially equal lengths;
the collector insert has a generally parallelepiped exterior shape;
the collector insert is configured to fit snugly into the opening of each separator plate such that each separator plate can be guided by the collector insert when stacking the separator plates along the collector insert;
the collector insert has a non-circular outer contour when viewed along its extension axis;
the collector insert has a profiled outer contour when viewed along its extension axis.

The invention also relates to an electrochemical reactor comprising a plurality of separator plates and membrane-electrode assemblies stacked in a stacking direction and delimiting superimposed electrochemical cells, at least one collector being formed by aligned openings of the separator plates, with each of the electrochemical cells comprising a fluid chamber fluidly connected to said collector by a connection port, and a collector insert, as defined above, inserted in the collector.

The electrochemical reactor is for example a fuel cell, in particular a proton exchange membrane fuel cell, or an electrolyzer.

### BRIEF DESCRIPTION OF THE DRAWINGS

The invention and its advantages will be better understood from the following description, given only as a non-limiting example, and made with reference to the appended drawings, in which:

FIG. 1 is a schematic perspective view of an electrochemical reactor and a collector insert;

FIG. 2 is a cross-sectional view of the collector insert;

FIG. 3 is a partial cross-sectional view of the electrochemical reactor showing the collector insert inserted into the collector and an electrochemical cell of the electrochemical reactor; and

FIG. 4 illustrates a method for assembling the electrochemical reactor.

### DETAILED DESCRIPTION OF PREFERRED EMBODIMENTS

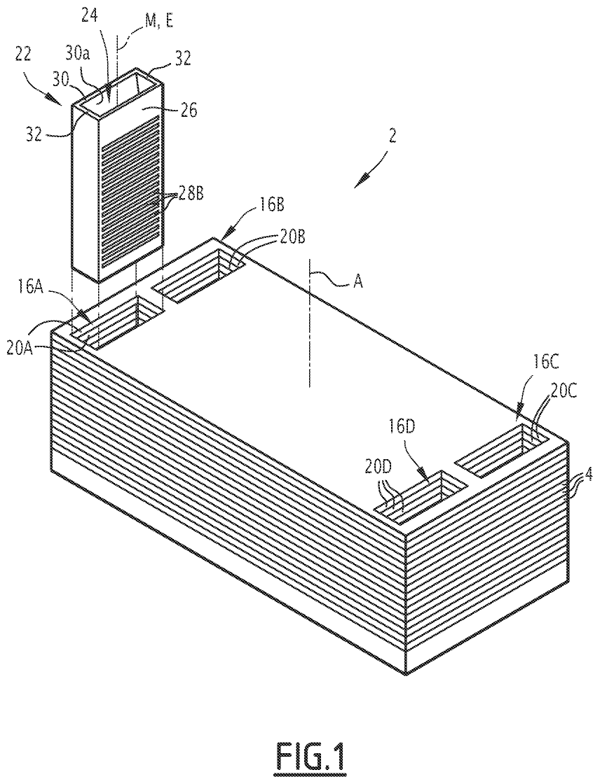

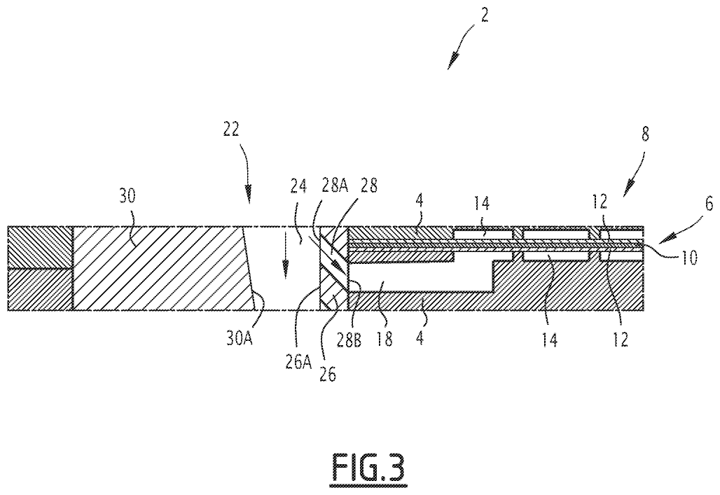

As illustrated in FIGS. 1 through 3, the electrochemical reactor 2 comprises a stack of separator plates 4 and membrane-electrode assemblies 6 (FIG. 3) forming a plurality of electrochemical cells 8 (FIG. 3) that are superimposed.

The separator plates 4 and the membrane-electrode assemblies 6 are stacked along a stacking direction A. Only the separator plates 4 are visible in FIG. 1, and a membrane-electrode assembly 6 is visible in FIG. 3.

As shown in FIG. 3, each electrochemical cell 8 is formed by a membrane-electrode assembly 6 sandwiched between two separator plates 4.

Each membrane-electrode assembly 6 is a laminate comprising an ion exchange membrane 10, in particular a proton exchange membrane, sandwiched between two electrodes 12.

In each electrochemical cell 8, each separator plate 4 is configured to channel a fluid along the face of the membrane-electrode assembly 6 facing said separator plate 4.

Each separator plate 4 has its face facing the membrane-electrode assembly 6 configured to define a fluid chamber 14 along with the membrane-electrode assembly 6, the fluid chamber 14 being configured for circulation of a fluid along that face of the membrane-electrode assembly 6.

Said face of the separator plate 4 has for example a plurality of grooves defining a flow field for fluid to flow along the membrane electrode assembly 6.

Each electrochemical cell 8 comprises two fluid chambers 14 located on opposite sides of the membrane-electrode assembly 6, with each fluid chamber 14 formed between the membrane-electrode assembly 6 and a respective separator plate 4 of the electrochemical cell 8.

In a known manner, the separator plates 4 of the electrochemical reactor 2 comprise bipolar separator plates and/or monopolar separator plates.

Each bipolar separator plate 4 is adapted to be arranged between two membrane-electrode assemblies 6, with each of the two opposing faces of the bipolar separator plate 4 configured to define a fluid chamber 14 along with a membrane-electrode assembly 6. Each bipolar separator plate 4 is common to two adjacent electrochemical cells 8.

Each monopolar separator plate 4 has only one of its two faces configured to define a fluid chamber 14 along with a membrane-electrode assembly 6 applied against that face. Each monopolar separator plate 4 is located at one end of the stack or between a membrane electrode assembly 6 of one electrochemical cell 8 and a monopolar separator plate 4 of another adjacent electrochemical cell 8.

In a preferred embodiment, the electrochemical reactor 2 comprises an alternating stack of bipolar separator plates 4 and membrane electrode assemblies 6, with a monopolar separator plate 4 at each end of the stack.

The electrochemical reactor 2 has a collector 16A in fluid communication with a fluid chamber 14 of each electrochemical cell 8 via a connection port 18 (FIG. 3).

The collector 16A is an inlet collector for supplying fluid to each fluid chamber 14 with which it is in fluid communication, or an outlet collector for recovering fluid from the outlet of each fluid chamber 14 with which it is in fluid communication.

As visible in FIG. 3, only one of the two fluid chambers 14 of each electrochemical cell 8 is connected to the collector 16A. The other is connected to another collector, for example, as will be described later.

The collector 16A is formed by aligned openings 20A of the stacked separator plates 4 of the electrochemical reactor 2. The collector 16A extends along a collector axis M parallel to the stacking direction A.

The openings 20A are aligned and have the same cross-section. The collector 16A has a constant cross-section along its collector axis M.

The electrochemical reactor 2 comprises a collector insert 22 configured to be inserted into the collector 16A and to define a main conduit 24 within the collector 16A, the main conduit 24 having a cross-sectional area that decreases from a first end 24A of the main conduit 24 toward a second end 24B of the main conduit 24.

The collector insert 22 extends along an extension axis E and is configured to be inserted into the collector 16A along its extension axis E, with the latter aligned with the collector axis M.

The collector insert 22 has a connecting wall 26 that has a first face 26A provided to delimit the main conduit 24 and a second face 26B opposite the first face 26A.

The collector insert 22 comprises a plurality of channels 28, each channel 28 extending through the connecting wall 26 between a first port 28A, opening on the first face 26A, and a second port 28B, opening on the second face 26B.

The first ports 28A are distributed along the first face 26A such that they are distributed along the main conduit 24 between the first end 24A and the second end 24B.

The second ports 28B are distributed along the second face 26B such that each second port 28B is located opposite a respective connection port 18 when the collector insert 22 is inserted into the collector 16A.

When collector insert 22 is inserted into collector 16A, each channel 28 connects the main conduit 24 to a respective connection port 18 for the flow of a fluid between the main conduit 24 and the fluid chamber 14 corresponding to that connection port 18.

The connection ports 18 of the fluid chambers 14 opening into the collector 16A are located on a common internal connection surface of the collector 16A.

When collector insert 22 is inserted into collector 16A, the second face 26B of connecting wall 26 is located opposite the internal connection surface, with each second port 28B opposite a respective connecting port 18.

Each channel 28 has a length taken between its first port 28A and its second port 28B.

Preferably, the channels 28 have equal lengths.

The connecting wall 26 has a thickness, taken between the first face 26A and the second face 26B, perpendicular to the extension axis E of the collector insert 22.

In one example embodiment, the connecting wall 26 has a constant thickness from one end of the main conduit 24 to the other, in particular from the first end 24A of the main conduit 24 toward the second end 24B of the main conduit 24.

In a particular example, the first face 26A and the second face 26B of the connecting wall 26 are substantially parallel to the extension axis E of the collector insert 2.

In one example, the collector insert 22 is hollow, with the main conduit 24 being defined within the collector insert 22.

The collector insert 22 has a channel wall 30, for example, with the main conduit 24 being defined between the connecting wall 26 and the channel wall 30, more specifically between the first face 26A of the connecting wall 26 and an inner face 30A of the channel wall 30 facing the first face 26A of the connecting wall 26.

The collector insert 22 comprises sidewalls 32 connecting the channeling wall 30 to the connecting wall 26, providing the main conduit 24 with a closed contour cross-section, such as a rectangular cross-section.

Preferably, the spacing between the connecting wall 26 and the channeling wall 30 decreases from the first end 24A of the main conduit 24 toward the second end 24B of the main conduit 24.

In one example embodiment, the first face 26A of the connecting wall 26 and the inner face 30A of the channeling wall 30 are planar and angled relative to each other such that they approach each other from the first end 24A of the main conduit 24 toward the second end 24B of the main conduit 24.

In one example embodiment, one of the first face 26A of the connecting wall 26 and the inner face 30A of the channeling wall 30 is parallel to the extension axis E, the other being inclined relative to the extension axis E such that the cross-sectional area of the main conduit 24 decreases from its first end 24A toward its second end 24B.

Preferably, the inner face 30A of the conduit wall 30 is inclined in relation to the extension axis E, with the first face 26A of the connecting wall 26 being parallel to the extension axis E.

In another example embodiment, the first face 26A of the connecting wall 26 and the inner face 30A of the channeling wall 30 are both planar and inclined in relation to the extension axis E.

Preferably, the collector insert 22 is configured to fit snugly into each of the openings 20A delimiting the collector 16A, such that each separator plate 4 can be guided by the collector insert 22 when stacking the separator plates 4 along the collector insert 22.

Advantageously, when viewed along its extension axis E, the collector insert 22 has a profiled and/or non-circular outer contour. This ensures that each separator plate 4 is guided by the collector insert 22 during the stacking process.

In one example embodiment, the collector insert 22 has a generally parallelepiped outer shape. The second face 26B of the connecting wall 26 defines an outer face of the collector insert 22.

In one example embodiment, as seen in FIG. 1, the second port 28B of each channel 28 has an elongated shape. In this case, the second ports 28B are preferably parallel to each other, and, even more preferably, elongated perpendicular to the extension axis E of the collector insert 22.

As illustrated in FIG. 3, collector 16A is an inlet collector, for example, provided for supplying fluid chambers 14 in fluid communication with collector 16A with a fluid.

In operation, the first end 24A of the main conduit 24 receives fluid flowing from the first end 24A to the second end 28B of the main conduit 24.

A portion of the fluid enters the first port 28A of each channel 28 and flows to the second port 28B of that channel 28 and feeds into the opposing connection port 18 to supply the corresponding fluid chamber 14.

The amount of fluid present in the main conduit 24 decreases from the first end 24A to the second end 24B due to a fraction of reactive fluid being drawn through each channel 28.

However, the gradual decrease in the cross-sectional area of the main conduit 24 from the first end 24A to the second end 24B maintains a substantially constant fluid flow velocity along the entire length of the main conduit 24, thereby providing a uniform flow of fluid to the fluid chambers 14 connected to the collector 16A.

The presence of channels 28 between the first face 26A and the second face 26B allows each channel 28 to be individually tailored to achieve proper fluid flow between the collector 16A and the fluid chambers 14 connected to the collector 16A.

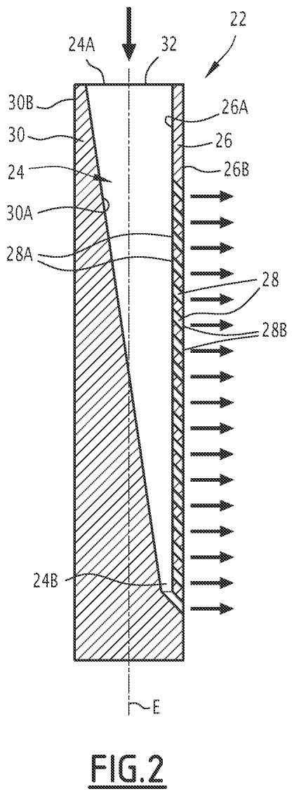

In FIG. 2, the channels 28 are substantially straight, parallel and of the same constant cross-sectional area along each channel 28.

However, it is possible to tailor each channel 28, such as its length, shape, and/or constant or variable cross-sectional area, so as to uniformly distribute fluid to the fluid chambers 14 connected to the collector 16A.

The collector insert 22 is manufactured for example by an additive manufacturing method (also known as “3D printing”). This allows the main conduit 24 and each channel 28 to be formed into the desired shapes.

As noted above, each electrochemical cell 8 has two fluid chambers 14, located on either side of the membrane-electrode assembly 6 of that electrochemical cell 8.

In a variant, the collector 16A is an output collector. The collector insert 22 then also promotes a uniform flow of fluid out of the fluid chambers 14 that open into this collector 16A, and thus a uniform flow of fluid through these fluid chambers 14 into the various electrochemical cells 8.

A single collector 16A receiving a collector insert 22 has been shown in FIG. 1 and described for simplicity.

As illustrated in FIG. 1, the electrochemical reactor 2 may comprise multiple collectors, such as four collectors 16A, 16B, 16C, 16D, each formed by aligned openings 20A, 20B, 20C, 20C of the separator plates 4.

Each collector 16A, 16B, 16C, 16D is fluidly connected to only one of the two fluid chambers 14 of each electrochemical cell 8. Each collector 16A, 16B, 16C, 16D is an inlet collector or an outlet collector. Each fluid chamber 14 is fluidly connected to two of the collectors 16A, 16B, 16C, 16D, one being an inlet collector and the other being an outlet collector.

A single collector 16A may receive a collector insert 22. In a variant, at least two of the collectors 16A, 16B, 16C, 16D, receive a collector insert 22 similar to that of FIGS. 1 to 3.

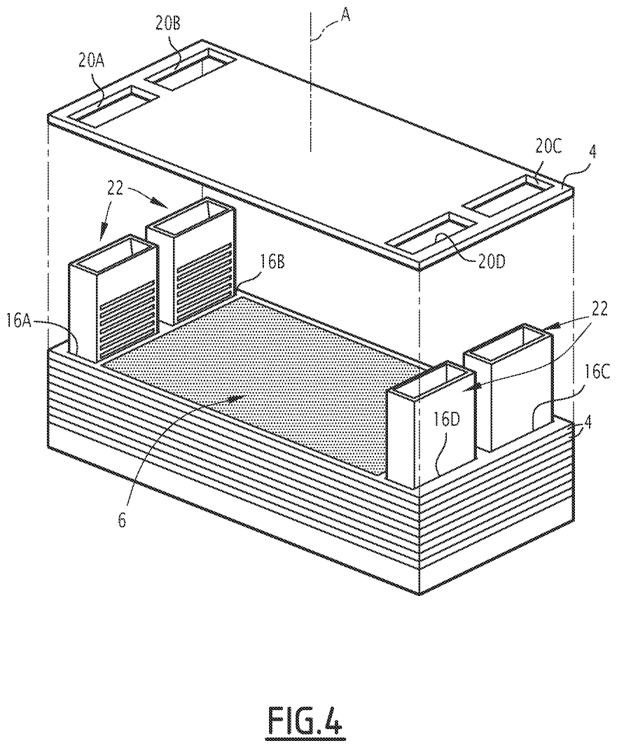

In particular, and as in the example embodiment shown in FIG. 4, each of the collectors 16A, 16B, 16C, 16D receives a respective collector insert 22 similar to that of FIGS. 1 to 3.

The electrochemical reactor 2 comprises for example a collector insert 22 inserted into a collector 16A feeding fluid chambers 14 located on a first side of the membrane electrode assemblies 6, a collector insert 22 inserted into a collector 16B feeding fluid chambers 14 located on a second side of the membrane electrode assemblies 8, a collector insert 22 inserted into a collector 16C collecting fluid from the fluid chambers 14 on a first side of the membrane electrode assemblies 6 and/or a collector insert 22 inserted into a collector 16D collecting fluid from the fluid chambers 14 on a second side of the membrane electrode assemblies 6.

Furthermore, as illustrated in FIG. 4, regardless of the number of collector insert(s) 22 provided, each collector insert 22 could be used for guiding the separator plates 4 during stacking, in particular when the insert 22 has a profiled and/or non-circular outer contour, in particular a parallelepiped general outer shape.

According to an advantageous manufacturing method, the separator plates 4 are fitted one after the other onto at least one collector insert 22, used as a guide for stacking the separator plates 4, by passing each collector insert 22 through the corresponding opening 20A, 20B, 20C, 20D intended to define the collector 16A, 16B, 16C, 16D receiving this collector insert 22.

In the various example embodiments, the electrochemical reactor 2 is for example a fuel cell configured to generate electrical energy from a fuel fluid and an oxidizer fluid, by exchange of ions, in particular protons, between the fuel fluid and the oxidizer fluid.

The fuel fluid is for example dihydrogen and the oxidizing fluid is for example dioxygen or air. In this case, the ions exchanged across the ion exchange membrane 10 of each membrane-electrode assembly 6 are protons, the ion exchange membrane 10 being a proton exchange membrane (or PEM).

Such an electrochemical reactor 2 generally comprises two inlet collectors and two outlet collectors. One or more of these collectors may be provided with a collector insert 22.

In a variant, the electrochemical reactor 2 is an electrolyzer configured to use electrical energy to separate chemical species contained in a fluid, for example to generate dihydrogen and dioxygen from water.

Such an electrochemical reactor 2 typically includes an inlet collector for the reactant fluid and two outlet collectors. One or more of these collectors may be provided with a collector insert.

The invention is not limited to the example embodiments and variants discussed above, as other example embodiments and variants are conceivable.

1. A collector insert configured for insertion into a collector of an electrochemical reactor comprising a stack of separator plates and membrane-electrode assemblies that define electrochemical cells, the collector being formed by aligned openings of the separator plates, and each of the electrochemical cells comprising a fluid chamber fluidly connected to the collector by a connection port, the collector insert extending along an extension axis and being configured to be inserted into the collector defining within the collector a main conduit that has a cross-sectional area that decreases from a first end toward a second end of the main conduit, the collector insert comprising a connecting wall comprising a first face adapted to delimit the main conduit and a second face, and a plurality of channels each extending between a first port located on the first face and a second port located on the second face the first ports being distributed on the first face so as to be distributed along the main conduit, and the second ports being distributed on the second face such that each second port faces the connection port of the fluid chamber of a respective electrochemical cell when the collector insert is inserted into the collector.

2. The collector insert according to claim 1, wherein the collector insert is hollow, the main conduit being delimited within the collector insert.

3. The collector insert according to claim 1, wherein the collector insert has a channeling wall, the main conduit being defined between an inner face of the channeling wall and the first face of the connecting wall that face each other.

4. The collector insert according to claim 3, wherein the inner face of the channeling wall and the first face of the connecting wall are substantially planar and angled relative to each other such that the cross-sectional area of the main conduit decreases from the first end toward the second end.

5. The collector insert according to claim 1, wherein the second face of the connecting wall is substantially flat.

6. The collector insert according to claim 1, wherein the first ports are elongated and parallel to each other and/or the second ports are elongated and parallel to each other.

7. The collector insert according to claim 1, wherein the connecting wall has a thickness, taken between the first face and the second face, which is substantially constant from the first end of the main conduit towards the second end of the main conduit.

8. The collector insert according to claim 1, wherein each channel has a length, taken along the channel between the channel's first port and the channel's second port, the channels having substantially equal lengths.

9. The collector insert according to claim 1, wherein the collector insert has a generally parallelepiped exterior shape.

10. The collector insert according to claim 1, wherein the collector insert is configured to fit snugly within the opening of each separator plate such that each separator plate can be guided by the collector insert when stacking the separator plates along the collector insert.

11. The collector insert according to claim 1, wherein the collector insert has a non-circular outer contour when viewed along the collector's extension axis.

12. The collector insert according to claim 1, wherein the collector insert has a profiled outer contour when viewed along the collector's extension axis.

13. An electrochemical reactor comprising a plurality of separator plates and membrane-electrode assemblies stacked along a stacking direction and delimiting superimposed electrochemical cells, at least one collector being formed by aligned openings of the separator plates, each of the electrochemical cells comprising a fluid chamber fluidly connected to said collector by a connection port, and a collector insert according to claim 1 inserted in the collector.

14. The electrochemical reactor according to claim 13, the electrochemical reactor being a fuel cell, a proton exchange membrane fuel cell or an electrolyzer.
